(19) United States
(12) Patent Application Publication
(10) Pub. No.: US 2023/0026369 A1
(43) Pub. Date: Jan. 26, 2023

(54) HARDWARE ACCELERATION FOR INTERFACE TYPE CONVERSIONS

(71) Applicant: Intel Corporation, Santa Clara, CA (US)

(72) Inventor: Mingqiu Sun, Beaverton, OR (US)

(73) Assignee: Intel Corporation, Santa Clara, CA (US)

(21) Appl. No.: 17/957,953

(22) Filed: Sep. 30, 2022

(51) Int. Cl. G06F 9/54

(52) U.S. Cl. CPC G06F 9/541; G06F 9/544

(57) ABSTRACT

Technologies include an interface processor configured to be communicatively coupled to a memory and a first processor. The interface processor is to obtain, from a first module compiled from a first software language, first data having a first native type of the first software language. The interface processor is further to convert the first data into second data having a first interface type, convert the second data having the first interface type into third data having a second native type of a second software language, and provide the third data to a second module associated with the second software language. The first software language may be compiled to WebAssembly binary code. The second software language may also be compiled to WebAssembly binary code and may be different than the first software language.

### BACKGROUND

A web application is software code that runs in a web browser, and a web browser facilitates access to local websites or remote websites in the World Wide Web. JavaScript is a high-level programming language that is independent of host architecture and ubiquitous in web applications. Powerful client-side and server-side capabilities are possible with JavaScript's frameworks, libraries, and tools. For resource intensive use cases, however, performance problems may be present in web applications developed with JavaScript. More recently, WebAssembly was developed as a low-level programming language having a portable binary code format that is also independent of host architecture. WebAssembly, however, is capable of running with near native performance and can be a compilation target for other low-level languages. Continued improvements to achieve the performance potential of WebAssembly on various architectures are desirable.

### BRIEF DESCRIPTION OF THE DRAWINGS

The present disclosure is best understood from the following detailed description when read with the accompanying figures.

FIG. 1 is a simplified illustration of an operating environment that includes a host in communication with a browser, in accordance with various embodiments.

FIGS. 2A-2B illustrate examples of configurations of Web Assembly runtime environments and respective Web Assembly System Interfaces.

FIG. 3 is a simplified illustration of various types of WebAssembly modules in communication with different type systems and modules according to at least one embodiment.

FIG. 4 illustrates hardware accelerated uplifting functions and lowering functions to perform interface type conversions according to at least one embodiment.

FIG. 5 is a simplified illustration of possible memory allocated for two modules in communication via an interface type processor unit (ITPU) according to at least one embodiment.

FIG. 6 is a simplified flow chart illustrating possible operations that may be performed to enable communication between two modules via an ITPU according to at least one embodiment.

FIG. 7 is a block diagram of an example compute node that may include any of the embodiments disclosed herein.

FIG. 8 illustrates a multi-processor environment in which embodiments may be implemented.

FIG. 9 is a block diagram of an example processor unit to execute computer-executable instructions as part of implementing technologies described herein

### DETAILED DESCRIPTION

The present disclosure provides various possible embodiments, or examples, of systems, methods, apparatuses, architectures, and machine readable media for hardware acceleration of interface type conversion functions for data passed between communicating components or modules and hardware-enforced shared nothing memory protection, for modules compiled to an instruction format of a software language having a managed runtime (e.g., code whose execution is managed by a runtime). Executions of WebAssembly code and JavaScript code, for example, are managed by runtimes. Particular embodiments disclosed herein provide hardware acceleration of conversion functions for interface types of WebAssembly to a dedicated interface type processor unit (ITPU). In addition, a shared memory can be allocated to enable interface type communications between a caller module and a callee module, where at least one of the modules is compiled to a binary instruction format such as WebAssembly.

For purposes of illustrating embodiments of hardware acceleration of type conversion functions and hardware-enforced shared memory protection, it is helpful to understand the characteristics of platform-independent software languages, such as WebAssembly and JavaScript, which can be used in web applications and beyond. Accordingly, the following introductory information provides context for understanding the embodiments disclosed herein.

Increased Web usage has led to increasingly sophisticated and software-demanding Web applications. This increased demand has highlighted deficiencies in the efficiency of JavaScript, the current software language commonly used for Web applications. WebAssembly (also sometimes referred to as WebAsm or WASM) is a collaboratively developed portable low-level bytecode designed to improve upon the deficiencies of JavaScript. WebAssembly is architecture independent (i.e., it is language-independent, hardware-independent, and platform-independent), and suitable for both Web use cases and non-Web use cases. WebAssembly computation is based on a stack machine with an implicit operand stack.

Because of the architecture-independence of JavaScript and WebAssembly, in practice, a host receiving a JavaScript file or WebAssembly program may employ a respective just-in-time (JIT) compilation module to translate or JIT software compile the JavaScript file or WebAssembly program into native machine code that is specifically optimized for the host architecture (e.g., a host processing unit, such as, a complex instruction set computer/architecture (CISC) or a reduced instruction set computer/architecture (RISC, RISC-V) that has a specific machine architecture and language). Often, the JIT compile operations are done in host software using host-specific libraries. In other scenarios, the portable binary code format of WebAssembly can be compiled ahead of time (AOT) and/or can be interpreted. Additionally, WebAssembly, is capable of running with near native performance and can be a compilation target for other low-level languages in addition to higher-level languages.

In various embodiments, the JIT compilation module may be called part of a browser, chrome browser, chrome V8 browser, JavaScript engine, just in time (JIT) compiler, or similar. In a non-limiting example, a Chrome browser sees a javascript.jsp file or WASM file from web and calls a chrome V8 Library to do the JIT compilation. Currently JIT compiling (“jitting”) is done instruction by instruction.

The software environment in which jitting is done is called a runtime or runtime environment. The WASM jitting is performed in a WASM runtime environment. The jitting is often performed instruction by instruction, therefore, efficiently jitting the javascript.jsp file or WebAssembly code would mandate a good match between a WASM runtime intermediate representation (WASM_IR) of received JavaScript or WebAssembly instructions and the hardware instruction set (native machine code) of the processor.

A WebAssembly component model defines how modules may be composed within an application or library. The component model provides mechanisms for dynamically linking modules into components, and components into higher-level components. The component model also provides interface types that define a module interface for high level data types (e.g., records, arrays, etc.). Interface types are not concrete (or native) types on which operations are performed. Rather, interface types provide an abstract representation of data that may be generated based on one native type and that may be consumed based on another (or the same) native type. Interface types enable representation of data based on complicated native types. WASM interface types enable WASM module-to-module communication (including inter-component communication). In other embodiments, a universal interface type could enable module-to-module communication where one module runs in its native runtime, module-to-system communication, and system-to-module communication. In yet another embodiment, an intra-component interface type could enable WASM module-to-module communications within a component, where communicating WASM modules are linked or instantiated.

Transformations of data from a native type to an interface type can be achieved by interface adapters. Consider a caller module compiled into WASM target code from a first software language that calls a second module compiled into WASM target code from a second software language. In this scenario, an “uplifting” adapter can be used to convert return data generated by the callee module based on a native type of the native software language of the callee module (e.g., second software language) into return data having an appropriate interface type. The “uplifted” return data (having the appropriate interface type) can be converted by a “lowering” adapter into return data having a native type of the software language of the caller module (e.g., first software language). The resulting “lowered” return data may then be consumed by the caller module. Additionally, an uplifting adapter may be used to convert a parameter generated by the caller module based on a native type of the software language of the caller module into a parameter having an appropriate interface type. The “uplifted” parameter (having the appropriate interface type) can be converted by a lowering adapter into a parameter having a native type of the software language of the callee module. An adapter may include a sequence of instructions to perform the desired conversions. These additional instructions may further negatively impact performance.

Unlike traditional inter-component invocations, which may involve shared memory messaging or a serialization and deserialization process, WASM shared nothing linking between modules (and components) does not allow memory sharing. For WASM inter-component or intra-component communications, multiple memory access operations may be required to pass data between the communicating components or modules (e.g., a caller module and a callee module). In a typical WASM environment, linear memory may be allocated for each of the communicating modules, and these distinct linear memory regions are not shared for security purposes. Consequently, multiple read/fetch and copy/write/store memory operations may be performed to complete an invocation of a callee module by a caller module. In this scenario, some portion of a linear memory region (e.g., containing parameter(s)) of a caller module is copied to another linear memory region, such as an interface type buffer. A relevant portion of the other linear memory region (e.g., containing return data) is copied back to the original linear memory region once the invocation is completed. Thus, the multiple memory accesses to pass data between communicating modules can further detrimentally impact performance.

Provided embodiments propose a technical solution for the above-described inefficiencies in the form of systems, apparatuses, and methods for hardware acceleration of interface type conversions in environments having inter-component, intra-component, module/component-to-system, or system-to-module/component communications. In at least one embodiment, hardware acceleration may be provided in a dedicated processing unit that performs simplistic computations to convert language-native types (e.g., C, C++, Go, Rust, etc.) to and from interface types. In a WASM environment, an interface type processing unit (ITPU) can provide hardware acceleration of uplifting and lowering functions to perform interface type conversions between communicating modules. In addition, a hardware-enforced shared-nothing protection mechanism may be used in these environments to enable the communicating modules to access the same shared memory. Furthermore, other desirable features and characteristics of the systems, apparatuses, and methods will become apparent from the subsequent detailed description and the appended claims, taken in conjunction with the accompanying drawings and the preceding background.

As the WASM component model matures and interface types proliferate, interface type conversion computations may become a sizable portion of the total computation in a data center. Offloading adapter functions to dedicated hardware, such as an ITPU as disclosed herein, may provide financial benefits as well as boosting performance and optimizing power usage. Additionally, implementing shared memory for communicating WASM modules can minimize memory copies that are needed to pass parameters and other data between the communicating modules. Thus, the performance of workloads with communicating WASM modules can be improved relative to other workloads without shared memory.

The terms “module,” “functional block,” “block,” “system,” and “engine” may be used herein, with functionality attributed to them. As one with skill in the art will appreciate, in various embodiments, the functionality of each of the module/blocks/systems/engines described herein can individually or collectively be achieved in various ways; such as, via an algorithm implemented in software and executed by a processor (e.g., a CPU, complex instruction set computer (CISC) device, a reduced instruction set computer (RISC, RISC-V), compute node, graphics processing unit (GPU), infrastructure processing unit (IPU), vision processing unit (VPU), deep learning processor (DLP), inference accelerators, etc.), processing system, as discrete logic or circuitry, as an application specific integrated circuit, as a field programmable gate array, etc., or a combination thereof. The approaches and methodologies presented herein can be utilized in various computer-based environments (including, but not limited to virtual machines, web servers, and stand-alone computers), edge computing environments, network environments, and/or database system environments.

As used herein, the terms “operating”, “executing”, or “running” as they pertain to software or firmware in relation to a processor, processing unit, compute node, system, device, platform, or resource, are used interchangeably and can refer to software or firmware stored in one or more computer-readable storage media accessible by the system, device, platform or resource, even though the software or firmware instructions are not actively being executed by the system, device, platform, or resource.

As used herein, the term “circuitry” can comprise, singly or in any combination, non-programmable (hardwired) circuitry, programmable circuitry such as processor units, state machine circuitry, and/or firmware that stores instructions executable by programmable circuitry.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner.

Reference is now made to the drawings, which are not necessarily drawn to scale, wherein similar or same numbers may be used to designate same or similar parts in different figures. The use of similar or same numbers in different figures does not mean all figures including similar or same numbers constitute a single or same embodiment. Like numerals having different letter suffixes may represent different instances of similar components. Elements described as “connected” may be in direct physical or electrical contact with each other, whereas elements described as “coupled” may co-operate or interact with each other, but they may or may not be in direct physical or electrical contact. The drawings illustrate generally, by way of example, but not by way of limitation, various embodiments discussed in the present document.

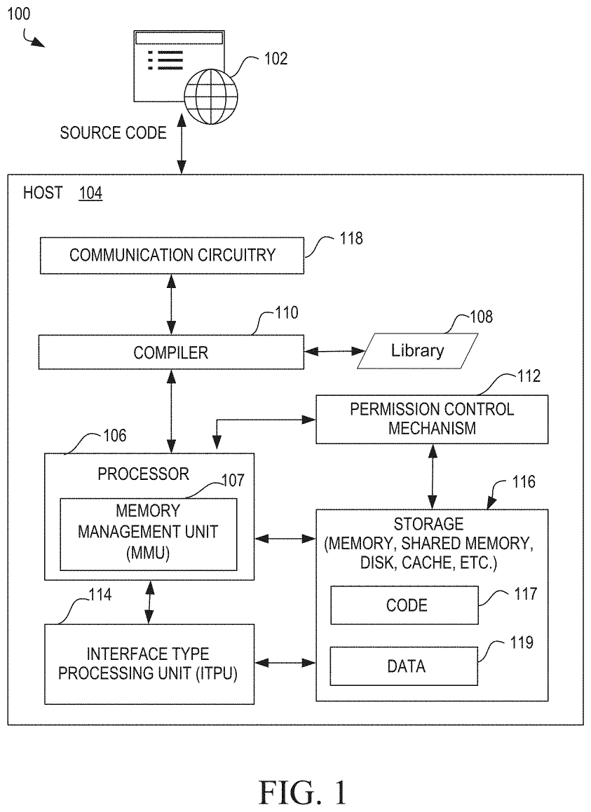

Turning now to FIG. 1, an operating environment 100 includes a simplified illustration of a host 104 configured to receive source code (e.g., software instructions), run a browser, and parse a web page. The host 104 is in operational communication via communication circuitry 118 with the source 102 of a JavaScript file or WASM_IR. The host 104, via the communication circuitry 118 perform instruction monitoring.

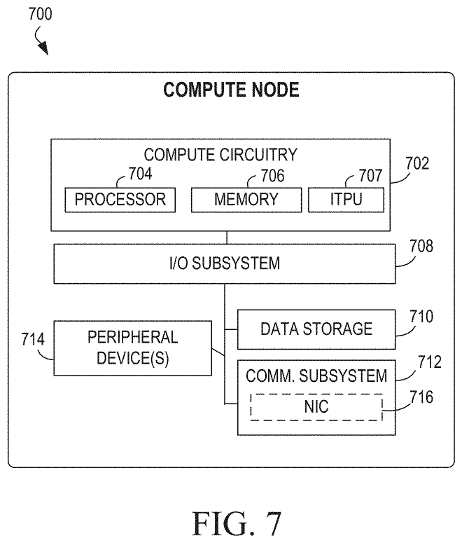

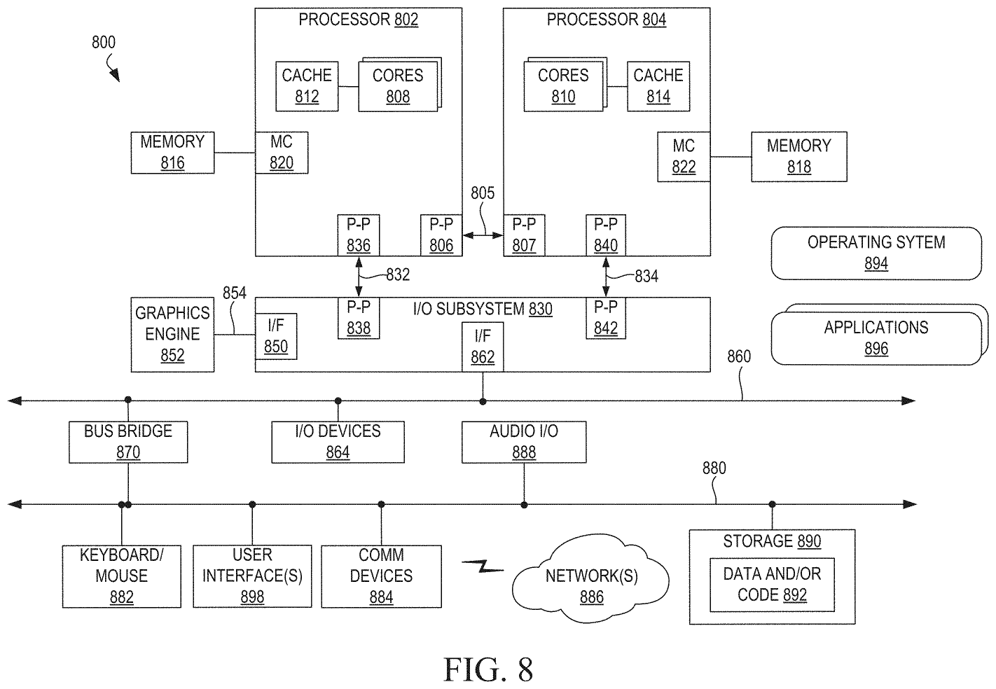

In practice, the source 102 may be one of a plurality of sources that each independently may transmit a JavaScript file or WASM_IR to the host 104. As described herein, the host 104 relies on at least one instruction set architecture, indicated generally with processor 106, and together they embody a language and hardware architecture. The host 104 includes at least one type of storage for data and code, indicated generally with storage 116. As may be appreciated, in practice, the host 104 may be a complex computer node or computer processing system, and may include or be integrated with many more components and peripheral devices (see, for example, FIG. 7, compute node 700, and FIG. 8, computing system 800).

In a non-limiting example, the host 104 software comprises x86 instructions and the host 104 is configured to run a Chrome browser and perform x86 instruction monitoring. The host 104 architecture includes or is upgraded to include a new compiler 110. Compiler 110 may be a JIT compiler in one example, which can be realized as hardware (circuitry) or an algorithm or set of rules embodied in software (e.g., stored in the memory 116) and executed by the processor 106. In one example, compiler 110 manages JIT compile operations for the host 104. In other embodiments, compiler 110 may be an AOT compiler. In yet further embodiments, an interpreter may be used instead of, or in addition to, compiler 110. In some scenarios, the source code may be compiled ahead of time on another host and communicated to host 104 via communication circuitry 118, for example.

Compiler 110 is depicted as a separate functional block or module for discussion; however, in practice, compiler 110 logic may be integrated with the host processor 106 as software, hardware, or a combination thereof. Accordingly, compiler 110 may be updated during updates to the host 104 software. Compiler 110 executes a compile operation, and in doing so, compiler 110 references a host library 108. The host specific library 108 is configured with microcode (also referred to as machine code) instructions that are native to the host 104 architecture, so that the compile operation effectively translates incoming source code into native machine code.

Storage 116 can include any suitable memory device(s) to achieve the hardware acceleration and shared memory embodiments described herein. For example, storage 116 can include any volatile or non-volatile memory device, cache (e.g., level 1 (L1), level 2 (L2), etc.), or any other suitable local or remote memory element or elements. Memory devices store any suitable data 119 (e.g., variables, parameters, passed parameters, passed return values, memory access permissions, etc.) that is used by one or more processors 106 of host 104 and/or by an interface type processing unit (ITPU) 114. Memory devices also store code 117 utilized by other elements of host 104, including software embedded in a computer readable medium, and/or encoded logic incorporated in hardware or otherwise stored (e.g., firmware). At least some code 117 (e.g., instructions) may be executed by the processors 106 and/or the ITPU 114 of host 104 and/or other processing elements in the same host 104 or different hosts of operating environment 100 to provide functionality associated with operating environment 100.

Storage 116 in host 104 may be implemented in host 104 to enable linear memory to be provided to at least some application programs. In one example, a memory management unit (MMU) 107 of processor 106 can manage virtual (linear) memory for processes (or instances of components and/or modules) running in host 104. Linear memory appears to an application program as a single contiguous address space. Linear addresses are translated to physical addresses as needed using linear-to-physical page tables. Conversely, physical memory addresses can be translated to linear memory addresses as needed using physical-to-linear page tables. The MMU 107 is a hardware device that performs the linear and physical address translations.

In one or more embodiments, a permission control mechanism 112 may be provided in host 104 to enable certain portions of linear memory to be shared by communicating modules or components where at least one communicating module is compiled from another software language into target code such as WASM. Permission control mechanism 112 is a hardware-enforced shared nothing technique in which shared linear memory is used in conjunction with hardware acceleration of interface type conversions. More particularly, hardware-enforced rules (e.g., access permissions) are assigned to the communicating modules to permit the communicating modules to share a designated memory region during the invocation of one module by the other.

Any suitable permission control mechanism 112 may be used to implement the hardware enforced rules including, but not limited to, Intel® Memory Protection Key technology. In one example, page tables of linear memory may be tagged with permissions (e.g., read/write, read only, etc.) that enable a particular module to appropriately access a particular page of memory. The MMU 107 may include the page tables and perform address translation. Accordingly, the MMU 107 may enforce the access permissions tagged in the page tables.

As will be further described herein, different linear memory spaces may be allocated in linear memory for different programs (e.g., modules, components). A portion of a linear memory space allocated for a particular module, or a component composed of modules, can be designated as a shared memory region. Another module can be given permission to access the shared memory region. For example, a portion of a linear memory space allocated for a caller module may be shared with a callee module, which is called by the caller module. The callee module may be assigned read access permission to enable the callee module to read data from the shared memory region that is passed by the caller module and to store data that is returned by the callee module to the caller module. Accordingly, the caller module would typically have read/write access to the shared memory region. If the callee module returns data to the caller module, then the callee module may also have read/write access to the shared memory region. However, if the callee module does not return data to the caller module, then the callee module may only have read access to the shared memory region.

In at least one embodiment, ITPU 114 is a dedicated hardware computing device that includes any suitable type of processor or processing circuitry that includes support for arithmetic and memory operations. ITPU 114 (also referred to herein as an ‘interface processor’ or ‘interface processing circuitry’) can be programmed to use hardware computations to perform highly efficient interface type conversions of data (e.g., parameters, return values, etc. of various native types of various software languages) passed between communicating modules where at least one of the modules is compiled to target code, such as WASM, from another software language. A ‘hardware computation’ as used herein is intended to include one or more arithmetic operations (e.g., addition, subtraction, multiplication, division), one or more memory operations (e.g., fetch/read/load, store/write), or a combination thereof.

ITPU 114 may be initiated per invocation and loaded with a sequence of instructions for the particular interface type conversion to be performed by the ITPU. An invocation is intended to mean each instance of one module communicating data to another module (e.g., a parameter in a call instruction, a return value in a return instruction, etc.). The sequence of instructions for a particular interface type conversion may vary depending upon whether the data being communicated is being “uplifted” to the ITPU 114 or “lowered” to one of the communicating modules. The sequence of instructions may also vary depending on the language native type associated with the module that is sending or receiving the data involved in the particular conversion and corresponding sequence of instructions, and the data native type itself (e.g., integer, array, floating point, string, etc.) that is involved in the conversion.

In some scenarios, an ITPU 114 may be implemented in a complex instruction set computer or CISC. Because simple computations may be used to perform the conversion functions, however, a substantial part of an instruction set architecture of a modern computer may be rendered unnecessary to achieve hardware acceleration of interface type conversions. Thus, in at least some scenarios, a reduced instruction set computer or RISC-V may be used to implement the ITPU 114. RISC-V is an open standard instruction set architecture (ISA). The RISC-V ISA is a load-store architecture that is highly configurable and designed for a wide range of uses. Accordingly, implementation of a WASM interface type acceleration on a RISC-V system for simple type conversion functions can include a minimal set of instruction set architecture.

It should also be noted that, in alternative implementations, a RISC-V architecture may be used to realize a WASM-optimized CPU. Because the RISC-V ISA is highly configurable, close matching of the RISC-V ISA to WASM's instruction set ensures minimal waste of silicon real estate for maximum power and performance. Native stack support in the CPU can be provided to optimize performance for a stack-based virtual machine such as WASM.

As mentioned, WASM is a collaboratively developed portable low-level bytecode designed to improve upon the deficiencies of JavaScript. A WebAssembly component model defines how modules may be composed within an application or library. In various scenarios, a WASM environment is developed based on a component model in which code is organized in modules that have a shared-nothing inter-component or intra-component invocation. A host (e.g., host 104), such as a virtual machine, container, or microservice, can be populated with multiple different WASM components (also referred to herein as WASM modules), which may be composed of one or more modules.

The current WASM module interface uses a shared-nothing interface in which communicating modules do not share a memory region. Instead, passing data between communicating modules, such as parameters and return values for example, involves multiple memory store and read operations. The shared-nothing interface enables software and hardware optimization via adaptors. Adapter instructions are inserted into communicating modules to perform interface type conversion of data having a particular native type of a particular native software language that is passed between the modules.

A WASM module contains definitions for functions, globals, tables, and memories. The definitions can be imported or exported. A module can define one memory that is a traditional linear memory that is mutable and may be shared. The code in a module is organized into functions. Functions can call each other, but functions cannot be nested within each other. Instantiating a module can be provided by a JavaScript virtual machine or an operating system. An instance of a module corresponds to a dynamic representation of the module, its defined memory, and an execution stack. A WASM computation can be initiated by invoking a function exported from the instance.

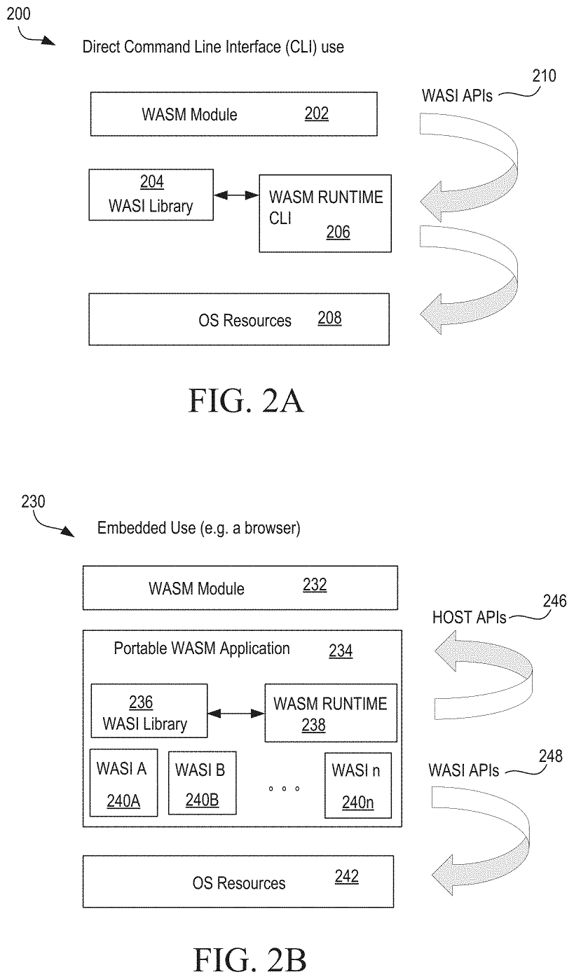

One example WASM runtime is “WASMTIME,” which is a jointly developed industry leading WebAssembly runtime; it includes a JIT compiler for WASM written in Rust. In various embodiments, a Web Assembly System Interface (WASI) that may be host specific (e.g., processor specific) is used to enable application specific protocols (e.g., for machine language, for machine learning, etc.) for communication and data sharing between the software environment running WASM (e.g., WASMTIME or other WASM runtime) and other host components. These concepts are illustrated in FIGS. 2A-2B. In FIG. 2A, a first software environment 200 illustrates a WASM module 202 embodied as a direct command line interface (CLI). A WASI library 204 is referenced during WASM runtime CLI 206, and operating system (OS) resources 208 of the host are utilized. A WASI application programming interface(s) 210 (“WASI API”) enables communication and data sharing between the components in software environment 200.

In FIG. 2B, a second software environment 230 illustrates a WASM module 232 in which WASM runtime and WASI are embedded in an application. In the embedded environment, a portable WASM application 234 includes a WASI library 236 that is referenced during WASM runtime 238. The portable WASM application 234 may be referred to as a user application. Software environment 230 may employ a host API 246 for communication and data sharing within the WASM application 234 and employ multiple WASI implementations 240A, 240B, through 240n for communication and data sharing between the portable WASM application 234 and host OS resources 242 (indicated generally with WASI APIs 248). Nonlimiting examples of WASI implementations include WASI for Neural Network (WASI-NN) and WASI-parallel. In various embodiments, different instances of WASI may be concurrently supported for communications with a host application, a native OS, bare metal, a Web polyfill, or similar. The portable WASM application 234 can transmit into the WASM runtime environment 238 model and encoding information, and the WASM runtime environment 238 may also reference models based thereon, such as, in a non-limiting example, a virtualized I/O machine learning (ML) model. Software environment 230 may represent a standalone environment, such as, a standalone desktop, an Internet of Things (IOT) environment, a cloud application (e.g., a content delivery network (CDN), function as a service (FaaS), an envoy proxy, or the like). In other scenarios, software environment 230 may represent a resource constrained environment, such as in 10T, embedding, or the like.

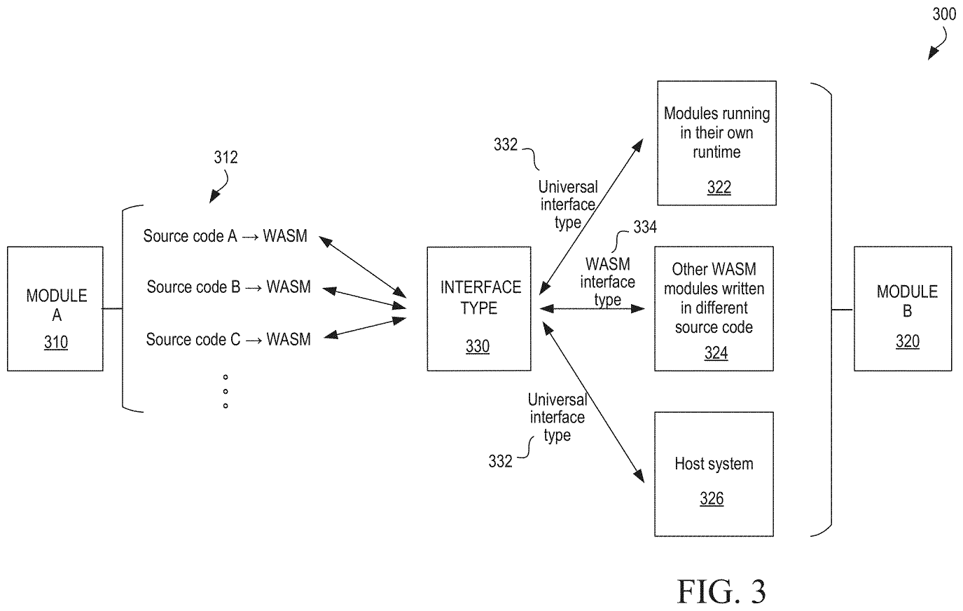

FIG. 3 illustrates example communications that are possible between WASM modules and different type modules and systems. As a compiler target, WASM provides a compilation target for a variety of software languages 312 (including low-level and higher-level software languages). The WASM compilation target, indicated by module A 310, can run on the Web or in other environments. Examples of software languages 312 (e.g., source code A, source code B, source code C, etc.) that can be compiled to WASM target code include, but are not limited to C#, C/C++, Rust, and Go software languages.

Interface type technology is the glue that links WASM components together. Generally, FIG. 3 illustrates interface types 330 linking WASM modules that are written in different languages and compiled to WASM target code. In one example, interface types 330 enable communication between a WASM module A 310 and module B 320, which represents another WASM module written in different source code 324 and compiled to WASM target code. Thus, module B 320 could be a WASM module compiled from a software language that is the same (or different) than the software language of the source code compiled to WASM module A 310. For example, a Rust module (e.g., module A 310) and a C++ module (e.g., module B 320) may communicate via interface types 330.

Adapter instructions can be used to convert language-native types of a sending module to an interface type, and to convert the interface type to a language-native type of a receiving module. The adapter instructions can use a WASM interface type 334 to perform the conversion from one WASM module (e.g., 310) to another WASM module (e.g., 324). For example, assume module A 310 is compiled from source code Rust into WASM target code, and calls module B 320, which is compiled from source code GO into WASM target code. In this scenario, module A 310 is a caller module, and module B 320 is a callee module. If the caller module 310 passes a Rust type parameter to the callee module 320, then a sequence of uplifting adapter instructions may be inserted in module A 310 to convert the Rust type parameter into an appropriate interface type parameter. Another sequence of lowering adapter instructions can be inserted in module B 320 to convert the interface type parameter into an appropriate Go type parameter that can be consumed by module B 320, the callee module. Often, multiple instructions are needed in the sequence of uplifting or lowering adapter instructions. In addition, the data passed between the modules is copied and stored to linear memory multiple times during the conversions and passing the data having different language-native types and interface type.

WASM interface types 334 are language agnostic and provide a specified mechanism for inter-component interactions of WASM. Interface types 330 may include basic, high-level data types that can be transmitted from module A 310 to module B 320, and vice-versa. Interface types 330 may not be concrete (or native) types on which operations are performed. Instead, interface types may represent the data being passed using basic types. For example, arrays may not be an interface type. Thus, when an array of integers [a, b, c] is passed between modules, uplifting adapter instructions could convert this into five integers: integer_array_type, array_length, a, b, c, where array_length=5. Thus, the five integers represent the interface type and contain all the information necessary for lowering adapter instructions to convert the five integers back into [a, b, c].

It should also be noted that, embodiments described herein, also allow for a universal interface type 332 that may be created to enable communication between a WASM module (e.g., module A 310) and many different type modules and systems. By way of example, a universal interface type 332 could be configured to enable communication between WASM module A 310 and a module 322 that is compiled based on its own native software language and that runs in its own runtime. By way of illustration, a language-native module may run in its own native runtime such as a Python module (which is not compiled to WASM target code) running in a Python runtime. In another example, a universal interface type 332 could be configured to to enable communication between WASM module A 310 and a module that provides access to a host system 326. For example, module B 320 may be embodied as a WebAssembly system interface (WASI) that provides a system interface to an operating system or application programming interface (API) of a browser of a host system.

It should be further noted that embodiments described herein further allow for an intra-component interface type. An intra-component interface type may be created to enable communication between modules of a single component. By way of example, an intra-component interface type could be configured to enable communication between WASM modules compiled from different software languages and linked in the same component.

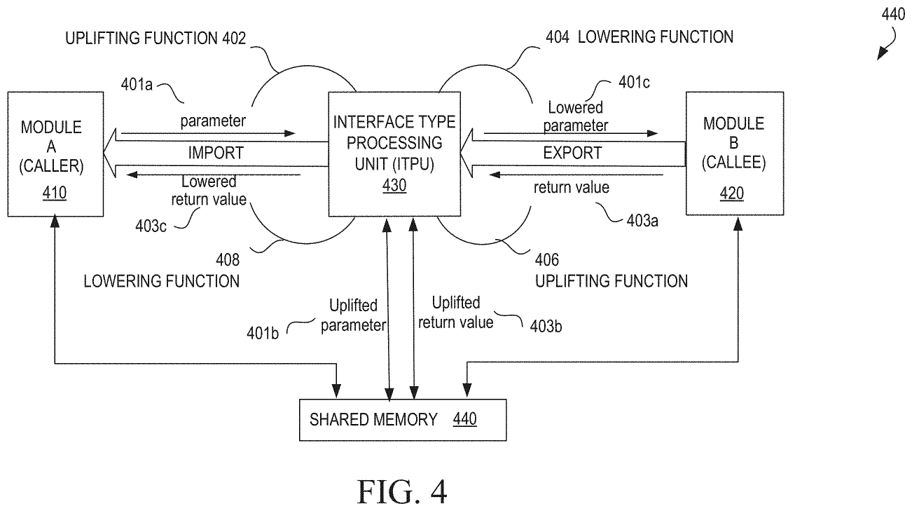

FIG. 4 illustrates hardware acceleration of interface type conversion computations by an interface type processing unit (ITPU) 430, which is an example of ITPU 114 of FIG. 1. The example in FIG. 4 illustrates possible communications between a module A 410 and a module B 420 that trigger the ITPU interface type conversion computations. ITPU 430 could be designed to perform WASM interface type conversions on communications between inter-component WASM modules (e.g., between module A 310 and module B 320/324), universal interface type conversions between a WASM module and a non-WASM module (e.g., between module A 310 and module B 320/322), universal interface type conversions between a WASM module and a host system (e.g., between module A 310 and module B 320/326), or intra-component interface type conversions for WASM modules within a single component (e.g., between module A 310 and another WASM module linked to or instantiated in the same component).

For illustration purposes only, FIG. 4 will be described with reference to inter-component WASM module communications and module A 410 and module B 420 are assumed to be WASM modules compiled from different source software languages. For example, module A 410 could be compiled from C++ language, and module B 420 could be compiled from Rust language. For ease of description, reference will be made to the particular example languages (C++ and Rust) in the description of FIG. 4 below. It should be understood, however, that the concepts described herein are not limited to a particular native software language.

FIG. 4 illustrates an example runtime environment 400 in which uplifting and lowering functions that may be performed when module A 410 is the caller and module B 420 is the callee. In this scenario, module A 410 calls (e.g., invokes) module B 420. The call passes a parameter 401a to be communicated to module B 420. The parameter 401a has a native type of C++ and may be stored by module A 410 in shared memory 440. Module A 410, as the caller, has read and write access to the shared memory 440. The ITPU 430 is also given read and write access to the shared memory 440.

In at least one embodiment, the shared memory 440 is a selected region of a linear memory allocation of module A 410, and appropriate memory access permissions (e.g., read only, read-and-write) are assigned to the callee, module B 420 to enable memory access to the selected region. In other embodiments, other suitable memory or storage may be used to implement shared memory 440. For example, an interface type buffer that is separate from the linear memory of the caller module and the linear memory of the callee module. A memory copy permission from and to the interface type buffer could be applied to enable the caller module and the callee module to access the buffer.

Module A 410 initiates the ITPU 430 to perform a first interface type conversion to convert parameter 401a based on an appropriate interface type. To initiate the ITPU, a first instruction sequence for a particular uplifting function 402, which can be performed to realize the interface type conversion, is loaded on the ITPU 430. In this example, uplifting function 402 is to convert parameter 401a, which has a first C++ language native type, based on a first interface type, which corresponds to the first C++ language native type. The instruction sequence to be loaded by the ITPU may be provided by the WASM runtime (e.g., 206, 238).

When the first instruction sequence is loaded on the ITPU 430, the ITPU obtains (e.g., receives, retrieves, fetches, loads, or otherwise gains access to) parameter 401a from module A 410 by, for example, fetching the parameter from shared memory 440. The first instruction sequence is executed by ITPU 430 to perform the uplifting function 402. The uplifting function 402 includes a hardware computation to convert parameter 401a into an uplifted parameter 401b having the first interface type (which corresponds to the C++ language native type of parameter 401a). The particular computation may vary based on the particular native type of the parameter 401a (e.g., a C++ integer type vs. a C++ floating-point type). ITPU 430 stores the uplifted parameter 401b having the first interface type to the shared memory 440.

The callee, module B 420, initiates the ITPU 430 to perform a second interface type conversion to convert the uplifted parameter 401b based on an appropriate language native type. To initiate the ITPU, a second instruction sequence for a particular lowering function 404, which can be performed to realize the interface type conversion, is loaded on the ITPU 430. In this example, lowering function 404 is to convert the uplifted parameter 401b, which has the first interface type, based on a first Rust language native type, which corresponds to the first interface type. The instruction sequence to be loaded by the ITPU may be provided by the WASM runtime (e.g., 206, 238)

When the second instruction sequence is loaded on the ITPU 430, the ITPU obtains (e.g., receives, retrieves, fetches, loads, or otherwise gains access to) the uplifted parameter 401b by, for example, fetching the uplifted parameter 401b from shared memory 440. The second instruction sequence is executed by ITPU 430 to perform the lowering function 404. The lowering function 404 includes a hardware computation to convert the uplifted parameter 401b having the first interface type into a lowered parameter 401c having the first Rust language native type (which corresponds to the first interface type). The particular computation may vary based on the particular native type to which the uplifted parameter 401b will be converted (e.g., a Rust integer type vs. a Rust floating-point type). ITPU 430 stores the lowered parameter 401c in the shared memory 440.

Module B 420 fetches and consumes lowered parameter 401c to perform module B's intended function. Module B 420 generates a return value 403a to be communicated back to module A 410. In this example, return value 403a has a second Rust language native type. It should be noted, however, that in other scenarios, the return value could have the first Rust language native type (e.g., the same native type as the lowered parameter 401c) or any other Rust language native type. The return value 403a may be stored by module B 420 in the shared memory 440. In some scenarios, module B 420, as the callee, may have read only access to the shared memory 440. In this scenario where module B 420 returns data to the caller module, however, module B 420 is provided with read and write access to the shared memory 440.

Module B 420 initiates the ITPU 430 to perform a third interface type conversion to convert return value 403a based on an appropriate interface type. To initiate the ITPU, a third instruction sequence for a particular uplifting function 406, which can be performed to realize the interface type conversion, is loaded on the ITPU 430. In this example, uplifting function 406 is to convert return value 403a, which has a second Rust language native type, based on a second interface type, which corresponds to the second Rust language native type. The instruction sequence to be loaded by the ITPU may be provided by the WASM runtime (e.g., 206, 238).

When the third instruction sequence is loaded on the ITPU 430, the ITPU obtains (e.g., receives, retrieves, fetches, loads, or otherwise gains access to) return value 403a from module A 410 by, for example, fetching return value 403a from shared memory 440. The third instruction sequence is executed by ITPU 430 to perform the uplifting function 406. The uplifting function 406 includes a hardware computation to convert return value 403a into an uplifted return value 403b having the second interface type (which corresponds to the second Rust language type). The particular computation depends on the particular native type of the return value 403a (e.g., a Rust array of integer types vs. a Rust array of floating-point types). ITPU 430 can store the uplifted return value 403b having the second interface type to the shared memory 440.

The caller, module A 410, initiates the ITPU 430 to perform a fourth interface type conversion to convert the uplifted return value 403b based on an appropriate C++ language native type. To initiate the ITPU, a fourth instruction sequence for the particular lowering function 408, which can be performed to realize the interface type conversion, is loaded on the ITPU 430. In this example, lowering function 408 is to convert the uplifted return value 403b, which has the second interface type, based on a second C++ language native type, which corresponds to the second interface type. The particular instruction sequence to be loaded by the ITPU may be provided by the WASM runtime (e.g., 206, 238).

When the fourth instruction sequence is loaded on the ITPU 430, the ITPU obtains (e.g., receives, retrieves, fetches, loads, or otherwise gains access to) the uplifted return value 403b by, for example, fetching the uplifted return value 403b from shared memory 440. The fourth instruction sequence is executed by ITPU 430 to perform the lowering function 408. The lowering function 408 includes a hardware computation to convert the uplifted return value 403b having the second interface type into a lowered return value 403c having the second C++ language native type (which corresponds to the second interface type). The particular computation depends on the particular native type to which the uplifted return value 403b will be converted (e.g., a C++ array of integer types vs. a C++ array of floating-point types). ITPU 430 can store the lowered return value 403c in the shared memory 440. Module A 410 can access the shared memory 440 to fetch and consume the lowered return value 403c.

It should be noted that the invocation of module B 420 by module A 410 may be reversed and module B 420 may call module A 410. The uplifting and lowering functions can also be reversed with particular instruction sequences loaded to the ITPU that reflect the particular type conversion that is needed. In this scenario, the same portion of memory or a different portion of memory may be shared. For example, the shared memory could be designated from a portion of the linear memory that has been allocated for the new caller, module B 420. It should also be noted that another possible embodiment includes two modules with at least one of the modules compiled to JavaScript, and the ITPU 430 configured to convert data (e.g., parameters, return values, etc.) to and from a JavaScript interface type to facilitate communication of the JavaScript modules.

Although the example described in FIG. 4 specifically referenced C++ and Rust native languages, it should be apparent that this was done for illustrative purposes only. Any number of different software languages may be compiled to WASM target code and may communicate via an ITPU 430 as described herein. Furthermore, depending on the particular native type, a one-to-one (1:1) mapping (or correspondence) between the native type and an interface type may not exist. In this scenario, one native type may map (or correspond) to multiple interface types for a single conversion. By way of example, ITPU 430 could convert a parameter having a given native type into data having multiple interface types that are mapped to the given native type. In other scenarios, one native type may have a one-to-one mapping between the native type and an interface type. As used herein, the term “mapping” is intended to mean a correspondence, relation, association, or any other suitable link between the items (e.g., native type and interface type) subject to the mapping.

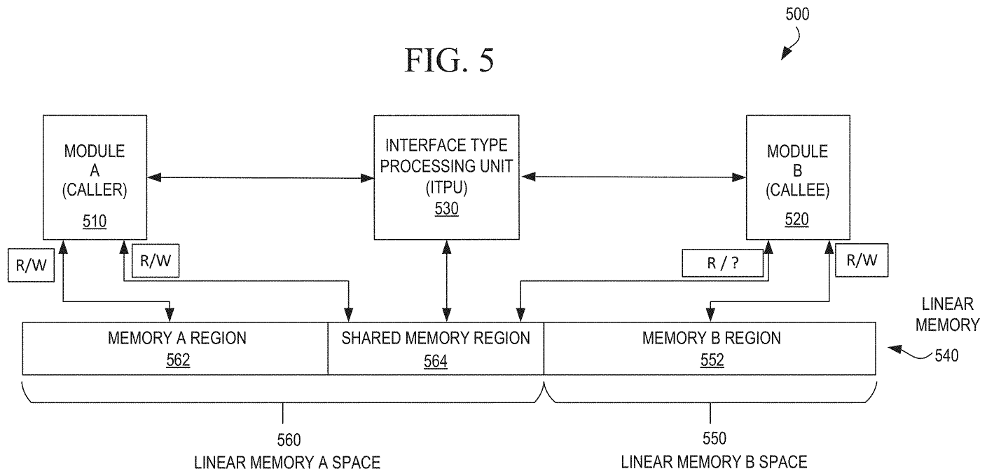

FIG. 5 illustrates an example runtime environment 500 illustrating possible memory access permissions of communicating WASM modules according to at least one embodiment. In runtime environment 500, module A 510 (caller) calls module B 520 (callee). Each module is a resulting compilation of a respective software language into target code, such as WASM. In other scenarios, one of the modules may be a WASI module of a host system (e.g., 326) or a module compiled to object code based on its native software language and running in its own runtime (e.g., 322). An interface type processing unit (ITPU) 530 performs hardware accelerated interface type conversions on data that is communicated between modules 510 and 520 during invocations.

In this example, linear memory space 540 is divided into different linear memory spaces allocated to different modules. Linear memory A space 560 is allocated to module A 510 and linear memory B space 550 is allocated to module B 520. Each linear memory space 550 and 560 include a contiguous set of linear memory addresses. In at least one embodiment, when module A 510 calls module B 520, module B 520 is granted access to a portion of the linear memory A space 560. The portion is indicated as shared memory region 564. Shared memory region 564 is one possible example of shared memory (e.g., 116, 440) previously shown and described herein.

In one example, the memory access granted to the callee (e.g., module B 520) is read permission. Write permission for the callee to the shared memory region 564 may be determined based on whether return values would be written back from module B 520. In some other computing paradigms, an input parameter can also be used as an output parameter. In this scenario, the callee may be granted write permission to the shared memory. If no data is returned by a callee to a caller, however, then the callee may only be given read access to the shared memory.

The access permissions for linear memory space 540 in this example includes memory A region 562 to which only module A 510 has read/write access, memory B region 552 to which only module B 520 has read/write access, and shared memory region 564 to which module A 510 has read/write access and module B 520 has read access. In addition, module B 520 may also be given write permission to shared memory region 564 if module B 520 returns data (e.g., return value, return parameter) to module A 510 after being called by module A 510.

This shared memory mechanism maintains isolation of the WASM modules without negatively impacting performance. In at least one example, WebAssembly runtime system (e.g., WASM runtime 206, 238) can use or implement a permission control mechanism (e.g., 112) to assign domain access permissions on behalf of the caller module. Any suitable hardware memory access mechanism may be used to assign and enforce domain access permissions in accordance with embodiments described herein. For example, the Intel® Memory Protection Key (MPK) technology could be implemented as the permission control mechanism in one or more embodiments. In one example, the permission control mechanism would offer a large number of domains (e.g., >16).

The permission control mechanism may be embodied as a userspace hardware mechanism in which page table permissions can be tagged with the desired permissions (e.g., read only, read/write, etc.). Once a page is tagged, the permissions may be changed from userspace with privileged access (e.g., a caller module invokes system call to change permissions). Assigned permissions may be enforced via an MMU (e.g., 107) and/or a processor (e.g., 106) and/or a memory controller, or a combination thereof. For example, an MMU (or page table) may be responsible for translating linear memory addresses to physical memory addresses. If a module attempts to access a page without the relevant memory access permission, then the MMU may cause a page fault and the access can be prevented. Otherwise, if the module accesses a page with the relevant memory access permission, then the access can be permitted.

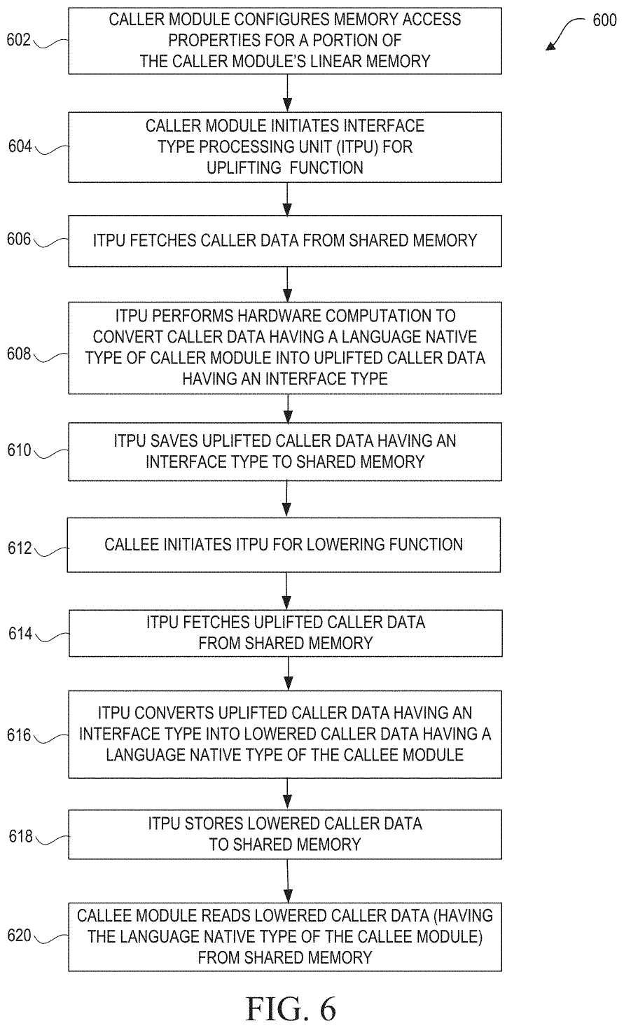

Turning to FIG. 6, FIG. 6 provides an example method 600 for module-to-module communication (e.g., inter-component) involving a caller module and a callee module that are compiled from respective software languages into target code, such as WASM, that can be run on the web (and beyond). Method 600 may be performed upon a caller module (e.g., 202, 232, 310, 320, 410, 510) executing a call instruction, or other similar instruction, to invoke a callee module to execute. In one or more implementations, a processor (e.g., 106) and/or a memory management unit (e.g., 107) performs one or more operations illustrated in method 600. Additionally, an ITPU (e.g., 114, 430, 530) performs one or more operations of method 600.

For illustrative purposes, the following description of the method 600 may refer to elements mentioned above in connection with FIG. 1. In various embodiments, portions of method 600 may be performed by different components of the described operating environment 100. It should be appreciated that method 600 may include any number of additional, fewer, or alternative operations and tasks, the tasks shown in FIG. 6 need not be performed in the illustrated order, and method 600 may be incorporated into a more comprehensive procedure or method, having additional functionality not described in detail herein. Moreover, one or more of the tasks shown in FIG. 6 could be omitted from an embodiment of the method 600 if the intended overall functionality remains intact. In particular, if the callee module is not configured to return data to caller module, then the ITPU may not be initiated and used for interface type conversions of data generated by the callee module.

Initially, a caller module and a callee module are instantiated in a computer operating environment (e.g., 100). In this example, the caller module and the callee module may be composed in respective WASM components or in the same WASM component. In other examples, however, one of the modules may be embodied as a module running in its own runtime (e.g., 322) or as a module in a host system (e.g., WASI module of host system 326).

At 602, the caller module configures memory access properties (e.g., read only permission, read-and-write permission) for a portion of the caller module's allocated linear memory referred to as a ‘shared memory region.’ A runtime system (e.g., WASM runtime 206, 238) is responsible for configuring the shared memory region. The caller module can initiate a call to the runtime system with parameters for the shared memory. Parameters may include without limitation, the size of the shared memory region, access permissions (e.g., for the callee module), structures of the shared memory region, etc.

The memory access properties are configured to allow the callee module to have access to the linear memory portion by a callee module. This shared memory region has different access permissions by different modules based on the nature of the invocation. Typically, a caller module has read and write permissions to the shared memory region. A callee module may have read only permission to the shared memory region if the callee module is not configured to pass data (e.g., return value or return parameter) to the caller module. If the callee module is configured to pass data back to the caller module when invoked (e.g., by a call instruction) by the caller module, then the callee module may be assigned read and write permissions for the shared memory region.

At 604, the caller module initiates the ITPU to perform a particular uplifting function that realizes an interface type conversion of caller data (e.g., parameter) being passed from the caller module to the callee module. To initiate the ITPU, the caller module can provide a first instruction sequence to be loaded on the ITPU to perform the uplifting function. The uplifting function is to convert the caller data, which is based on the software language native type associated with the caller module, into uplifted caller data having an interface type that corresponds to the (software) language native type associated with the caller module.

At 606, the ITPU fetches the caller data from a shared memory (e.g., shared memory region, separate shared interface buffer, etc.). At 608, the first instruction sequence is executed by the ITPU to perform the uplifting function. The uplifting function includes a hardware computation to convert the caller data having a language native type of the caller module into uplifted caller data having an interface type. At 610, the ITPU stores the uplifted caller data in the shared memory.

At 612, the callee module initiates the ITPU to perform a particular lowering function that realizes an interface type conversion of the uplifted caller data that is stored in the shared memory. To initiate the ITPU, the callee module can provide a second instruction sequence to be loaded on the ITPU to perform the lowering function. The lowering function is to convert the uplifted caller data having the interface type into lowered caller data having a (software) language native type associated with the callee module.

At 614, the ITPU fetches the uplifted caller data from the shared memory (e.g., shared memory region, separate shared interface buffer, etc.). At 616, the second instruction sequence is executed by the ITPU to perform the lowering function. The lowering function includes a hardware computation to convert the uplifted caller data having the interface type into lowered caller data having the other language native type associated with the callee module. At 618, the ITPU stores the lowered caller data (having the language native type of the callee module) in the shared memory.

At 620, the callee module can read the lowered caller data from the shared memory. Because the lowered caller data has a native type of the callee module, the lowered caller data can be consumed by the callee module. In some scenarios, the callee module may send a return value to the caller module. In this scenario, one or more of the operations described in FIG. 6 may be performed in reverse.

Other technologies may also be integrated in one or more embodiments described herein. In one example, cryptographic computing may be used to cryptographically secure the data stored in linear memory space 540. Cryptographic computing is related to pointer based data encryption and decryption in which a pointer to a memory location for data or code is encoded with a tag and/or other metadata (e.g., security context information) and may be used to derive at least a portion of tweak input to cryptographic (e.g., encryption and decryption) algorithms. Thus, a cryptographic binding can be created between the cryptographic addressing layer and data encryption and decryption. A pointer is also encoded with a linear address to a memory location where the data is stored. In some pointer encodings, a slice or segment of the linear address in the pointer includes a plurality of bits and is encrypted (and decrypted) based on a secret address key and a tweak based on the metadata and/or a portion of the linear address bits that are not being encrypted. Other pointers can be encoded with a plaintext memory address (e.g., linear address) and metadata.

Another technique that may be used in one or more embodiments is memory tagging technology in which tags are used to protect memory. For example, a memory tag is matched with a pointer tag for each granule of data accessed from memory. The matching is typically performed on a memory access instruction (e.g., on a load/store instruction). Matching a memory tag with a pointer tag per the minimum size granule of data (e.g., 16-byte granule, 8-byte granule, etc.) can be used to determine if the current pointer is accessing memory currently allocated to that pointer. If the tags do not match, an error is generated. If the tags match, then the memory access is allowed to proceed.

Thus, systems and methods for code generation for a plurality of architectures have been described. Advantageously, provided embodiments enable the flexibility of jitting a chunk of instructions at the same time, as a whole (i.e., in parallel), without requiring a 1:1 mapping, which increases efficiency of the code generation or compilation. Additionally, by enabling the collection of performance and power metrics, the provided embodiments enable optimization in code development.

The systems and methods described herein can be implemented in or performed by any of a variety of computing systems, including mobile computing systems (e.g., smartphones, handheld computers, tablet computers, laptop computers, portable gaming consoles, 2-in-1 convertible computers, portable all-in-one computers), non-mobile computing systems (e.g., desktop computers, servers, workstations, stationary gaming consoles, set-top boxes, smart televisions, rack-level computing solutions (e.g., blade, tray, or sled computing systems)), and embedded computing systems (e.g., computing systems that are part of a vehicle, smart home appliance, consumer electronics product or equipment, manufacturing equipment).

As used herein, the term “computing system” includes compute nodes, computing devices, and systems comprising multiple discrete physical components. In some embodiments, the computing systems are located in a data center, such as an enterprise data center (e.g., a data center owned and operated by a company and typically located on company premises), managed services data center (e.g., a data center managed by a third party on behalf of a company), a co-located data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves).

In the simplified example depicted in FIG. 7, a compute node 700 includes a compute engine (referred to herein as “compute circuitry”) 702, an input/output (I/O) subsystem 708, data storage 710, a communication circuitry subsystem 712, and, optionally, one or more peripheral devices 714. With respect to the present example, the compute node 700 or compute circuitry 702 may perform the operations and tasks attributed to the host 104. In other examples, respective compute nodes 700 may include other or additional components, such as those typically found in a computer (e.g., a display, peripheral devices, etc.). Additionally, in some examples, one or more of the illustrative components may be incorporated in, or otherwise form a portion of, another component. Compute node 700 illustrates a possible architecture of host 104 (or a portion thereof).

In some examples, the compute node 700 may be embodied as a single device such as an integrated circuit, an embedded system, a field-programmable gate array (FPGA), a system-on-a-chip (SOC), or other integrated system or device. In the illustrative example, the compute node 700 includes or is embodied as a processor 704, a memory 706, and an interface processor 707 (also referred to herein as an interface type processing unit or ITPU). The interface processor 707 may have the same or similar configuration as other ITPUs previously shown and described herein (e.g., ITPUs 114, 430, 530). The processor 704 may be embodied as any type of processor capable of performing the functions described herein (e.g., executing compile functions and executing an application). For example, the processor 704 may be embodied as a multi-core processor(s), a microcontroller, a processing unit, a specialized or special purpose processing unit, or other processor or processing/controlling circuit.

In some examples, the processor 704 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing, or managing server or data center hardware, managing service meshes, or collecting and distributing telemetry), outside of the CPU or general-purpose processing hardware. However, it will be understood that a xPU, a SOC, a CPU, and other variations of the processor 704 may work in coordination with each other to execute many types of operations and instructions within and on behalf of the compute node 700.

The memory 706 may be embodied as any type of volatile (e.g., dynamic random-access memory (DRAM), etc.) or non-volatile memory or data storage capable of performing the functions described herein. Volatile memory may be a storage medium that requires power to maintain the state of data stored by the medium. Non-limiting examples of volatile memory may include various types of random-access memory (RAM), such as DRAM or static random-access memory (SRAM). One particular type of DRAM that may be used in a memory module is synchronous dynamic random-access memory (SDRAM).

In an example, the memory device is a block addressable memory device, such as those based on NAND or NOR technologies. A memory device may also include a three-dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance.

In some examples, all or a portion of the memory 706 may be integrated into the processor 704. Some memory 706 may be separately implemented on the same compute node or separately provisioned (which may or may not be remote) and accessible by one or more elements of the compute node. Memory 706 may also include one or more caches (e.g., level 1 (L1), level 2 (L2), etc.), at least some of which may be integrated with one or more processors. The memory 706 may store various code and data (e.g., parameters, return values, shared memory access permissions, interface types, etc.) used during operation such as one or more applications, components, modules, or data operated on by the application(s), component(s), module(s), library(ies), and/or drivers. Memory 706 may store data and/or code that is used by other elements of the compute node, including without limitation processor 704 and ITPU 707. Data stored in memory 706 may also include software embedded in a computer readable medium, and/or encoded logic incorporated in hardware or otherwise stored (e.g., firmware).

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 and/or the main memory 706) and other components of the compute circuitry 702. For example, the I/O subsystem 708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices 710 may be embodied as any type of devices configured for short-term or long-term storage of data such as, for example, memory devices and circuits, memory cards, hard disk drives, solid-state drives, or other data storage devices. Individual data storage devices 710 may include a system partition that stores data and firmware code for the data storage device 710. Individual data storage devices 710 may also include one or more operating system partitions that store data files and executables for operating systems depending on, for example, the type of compute node 700.

The communication circuitry 712 may be embodied as any communication circuit, device, transceiver circuit, or collection thereof, capable of enabling communications over a network between the compute circuitry 702 and another compute device (e.g., an edge gateway of an implementing edge computing system).

The communication subsystem 712 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 712 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication subsystem 712 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication subsystem 712 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication subsystem 712 may operate in accordance with other wireless protocols in other embodiments. The communication subsystem 712 may include an antenna 722 to facilitate wireless communications and/or to receive other wireless communications (such as AM or FM radio transmissions).

In some embodiments, the communication subsystem 712 may manage wired communications, such as electrical, optical, or any other suitable communication protocols (e.g., IEEE 802.3 Ethernet standards). As noted above, the communication component 712 may include multiple communication components. For instance, a first communication subsystem 712 may be dedicated to shorter-range wireless communications such as Wi-Fi or Bluetooth, and a second communication subsystem 712 may be dedicated to longer-range wireless communications such as global positioning system (GPS), EDGE, GPRS, CDMA, WiMAX, LTE, EV-DO, or others. In some embodiments, a first communication subsystem 712 may be dedicated to wireless communications, and a second communication subsystem 712 may be dedicated to wired communications.

The illustrative communication subsystem 712 includes an optional network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another compute device (e.g., an edge gateway node). In some examples, the NIC 720 may be embodied as part of a system-on-a-chip (SoC) that includes one or more processors or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or alternatively, in such examples, the local memory of the NIC 720 may be integrated into one or more components of the client compute node at the board level, socket level, chip level, and/or other levels.

Additionally, in some examples, a respective compute node 700 may include one or more peripheral devices 714. Such peripheral devices 714 may include any type of peripheral device found in a compute device or server such as audio input devices, a display, other input/output devices, interface devices, and/or other peripheral devices, depending on the particular type of the compute node 700. In further examples, the compute node 700 may be embodied by a respective edge compute node (whether a client, gateway, or aggregation node) in an edge computing system or like forms of appliances, computers, subsystems, circuitry, or other components.

In other examples, the compute node 700 may be embodied as any type of device or collection of devices capable of performing various compute functions. Respective compute nodes 700 may be embodied as a type of device, appliance, computer, or other “thing” capable of communicating with other compute nodes that may be edge, networking, or endpoint components. For example, a compute device may be embodied as a personal computer, server, smartphone, a mobile compute device, a smart appliance, smart camera, an in-vehicle compute system (e.g., a navigation system), a weatherproof or weather-sealed computing appliance, a self-contained device within an outer case, shell, etc., or other device or system capable of performing the described functions.

FIG. 8 illustrates a multi-processor environment in which embodiments for hardware acceleration of interface type conversion and share memory, as previously described herein, may be implemented. Processor units 802 and 804 further comprise cache memories 812 and 814, respectively. The cache memories 812 and 814 can store data (e.g., instructions) utilized by one or more components of the processor units 802 and 804, such as the processor cores 808 and 810. The cache memories 812 and 814 can be part of a memory hierarchy for the computing system 800. For example, the cache memories 812 can locally store data that is also stored in a memory 816 to allow for faster access to the data by the processor unit 802. In some embodiments, the cache memories 812 and 814 can comprise multiple cache levels, such as level 1 (L1), level 2 (L2), level 3 (L3), level 4 (L4) and/or other caches or cache levels. In some embodiments, one or more levels of cache memory (e.g., L2, L3, L4) can be shared among multiple cores in a processor unit or among multiple processor units in an integrated circuit component. In some embodiments, the last level of cache memory on an integrated circuit component can be referred to as a last level cache (LLC). One or more of the higher levels of cache levels (the smaller and faster caches) in the memory hierarchy can be located on the same integrated circuit die as a processor core and one or more of the lower cache levels (the larger and slower caches) can be located on an integrated circuit dies that are physically separate from the processor core integrated circuit dies.

Although the computing system 800 is shown with two processor units, the computing system 800 can comprise any number of processor units. Further, a processor unit can comprise any number of processor cores. A processor unit can take various forms such as a central processing unit (CPU), a graphics processing unit (GPU), general-purpose GPU (GPGPU), accelerated processing unit (APU), field-programmable gate array (FPGA), neural network processing unit (NPU), data processor unit (DPU), accelerator (e.g., graphics accelerator, digital signal processor (DSP), compression accelerator, artificial intelligence (AI) accelerator), controller, or other types of processing units. As such, the processor unit can be referred to as an XPU (or xPU). Further, a processor unit can comprise one or more of these various types of processing units. In some embodiments, the computing system comprises one processor unit with multiple cores, and in other embodiments, the computing system comprises a single processor unit with a single core. As used herein, the terms “processor unit” and “processing unit” can refer to any processor, processor core, component, module, engine, circuitry, or any other processing element described or referenced herein.

In some embodiments, the computing system 800 can comprise one or more processor units that are heterogeneous or asymmetric to another processor unit in the computing system. There can be a variety of differences between the processing units in a system in terms of a spectrum of metrics of merit including architectural, microarchitectural, thermal, power consumption characteristics, and the like. These differences can effectively manifest themselves as asymmetry and heterogeneity among the processor units in a system.

The processor units 802 and 804 can be located in a single integrated circuit component (such as a multi-chip package (MCP) or multi-chip module (MCM)) or they can be located in separate integrated circuit components. An integrated circuit component comprising one or more processor units can comprise additional components, such as embedded DRAM, stacked high bandwidth memory (HBM), shared cache memories (e.g., L3, L4, LLC), input/output (I/O) controllers, or memory controllers. Any of the additional components can be located on the same integrated circuit die as a processor unit, or on one or more integrated circuit dies separate from the integrated circuit dies comprising the processor units. In some embodiments, these separate integrated circuit dies can be referred to as “chiplets.” In some embodiments where there is heterogeneity or asymmetry among processor units in a computing system, the heterogeneity or asymmetric can be among processor units located in the same integrated circuit component. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Processor units 802 and 804 further comprise memory controller logic (MC) 820 and 822. As shown in FIG. 8, MCs 820 and 822 control memories 816 and 818 coupled to the processor units 802 and 804, respectively. The memories 816 and 818 can comprise various types of volatile memory (e.g., dynamic random-access memory (DRAM), static random-access memory (SRAM)) and/or non-volatile memory (e.g., flash memory, chalcogenide-based phase-change non-volatile memories), and comprise one or more layers of the memory hierarchy of the computing system. While MCs 820 and 822 are illustrated as being integrated into the processor units 802 and 804, in alternative embodiments, the MCs can be external to a processor unit.

Processor units 802 and 804 are coupled to an Input/Output (I/O) subsystem 830 via point-to-point interconnections 832 and 834. The point-to-point interconnection 832 connects a point-to-point interface 836 of the processor unit 802 with a point-to-point interface 838 of the I/O subsystem 830, and the point-to-point interconnection 834 connects a point-to-point interface 840 of the processor unit 804 with a point-to-point interface 842 of the I/O subsystem 830. Input/Output subsystem 830 further includes an interface 850 to couple the I/O subsystem 830 to a graphics engine 852. The I/O subsystem 830 and the graphics engine 852 are coupled via a bus 854.

The Input/Output subsystem 830 is further coupled to a first bus 860 via an interface 862. The first bus 860 can be a Peripheral Component Interconnect Express (PCIe) bus or any other type of bus. Various I/O devices 864 can be coupled to the first bus 860. A bus bridge 870 can couple the first bus 860 to a second bus 880. In some embodiments, the second bus 880 can be a low pin count (LPC) bus. Various devices can be coupled to the second bus 880 including, for example, a keyboard/mouse 882, audio I/O devices 888, and a storage device 890, such as a hard disk drive, solid-state drive, or another storage device for storing data and/or computer-executable instructions (code) 892. The code 892 can comprise computer-executable instructions for performing methods described herein. Additional components that can be coupled to the second bus 880 include communication device(s) 884, which can provide for communication between the computing system 800 and one or more wired or wireless networks 886 (e.g. Wi-Fi, cellular, or satellite networks) via one or more wired or wireless communication links (e.g., wire, cable, Ethernet connection, radio-frequency (RF) channel, infrared channel, Wi-Fi channel) using one or more communication standards (e.g., IEEE 802.11 standard and its supplements).

In embodiments where the communication devices 884 support wireless communication, the communication devices 884 can comprise wireless communication components coupled to one or more antennas to support communication between the computing system 800 and external devices. The wireless communication components can support various wireless communication protocols and technologies such as Near Field Communication (NFC), IEEE 802.11 (Wi-Fi) variants, WiMax, Bluetooth, Zigbee, 4G Long Term Evolution (LTE), Code Division Multiplexing Access (CDMA), Universal Mobile Telecommunication System (UMTS) and Global System for Mobile Telecommunication (GSM), and 5G broadband cellular technologies. In addition, the wireless modems can support communication with one or more cellular networks for data and voice communications within a single cellular network, between cellular networks, or between the computing system and a public switched telephone network (PSTN).

The system 800 can comprise removable memory such as flash memory cards (e.g., SD (Secure Digital) cards), memory sticks, Subscriber Identity Module (SIM) cards). The memory in system 800 (including caches 812 and 814, memories 816 and 818, and storage device 890) can store data and/or computer-executable instructions for executing an operating system 894 and application programs 896. Example data includes web pages, text messages, images, sound files, and video data biometric thresholds for particular users or other data sets to be sent to and/or received from one or more network servers or other devices by the system 800 via the one or more wired or wireless networks 886, or for use by the system 800. The system 800 can also have access to external memory or storage (not shown) such as external hard drives or cloud-based storage.

The operating system 894 (also simplified to “OS” herein) can control the allocation and usage of the components illustrated in FIG. 8 and support the one or more application programs 896. The application programs 896 can include common computing system applications (e.g., email applications, calendars, contact managers, web browsers, messaging applications) as well as other computing applications.

In some embodiments, a hypervisor (or virtual machine manager) operates on the operating system 894 and the application programs 896 operate within one or more virtual machines operating on the hypervisor. In these embodiments, the hypervisor is a type-2 or hosted hypervisor as it is running on the operating system 894. In other hypervisor-based embodiments, the hypervisor is a type-1 or “bare-metal” hypervisor that runs directly on the platform resources of the computing system 894 without an intervening operating system layer.

In some embodiments, the applications 896 can operate within one or more containers. A container is a running instance of a container image, which is a package of binary images for one or more of the applications 896 and any libraries, configuration settings, and any other information that one or more applications 896 need for execution. A container image can conform to any container image format, such as Docker®, Appc, or LXC container image formats. In container-based embodiments, a container runtime engine, such as Docker Engine, LXU, or an open container initiative (OCI)-compatible container runtime (e.g., Railcar, CRI-O) operates on the operating system (or virtual machine monitor) to provide an interface between the containers and the operating system 894. An orchestrator can be responsible for management of the computing system 800 and various container-related tasks such as deploying container images to the computing system 894, monitoring the performance of deployed containers, and monitoring the utilization of the resources of the computing system 894.

The computing system 800 can support various additional input devices, represented generally as user interfaces 898, such as a touchscreen, microphone, monoscopic camera, stereoscopic camera, trackball, touchpad, trackpad, proximity sensor, light sensor, electrocardiogram (ECG) sensor, PPG (photoplethysmogram) sensor, galvanic skin response sensor, and one or more output devices, such as one or more speakers or displays. Other possible input and output devices include piezoelectric and other haptic I/O devices. Any of the input or output devices can be internal to, external to, or removably attachable with the system 800. External input and output devices can communicate with the system 800 via wired or wireless connections.

In addition, one or more of the user interfaces 898 may be natural user interfaces (NUIs). For example, the operating system 894 or applications 896 can comprise speech recognition logic as part of a voice user interface that allows a user to operate the system 800 via voice commands. Further, the computing system 800 can comprise input devices and logic that allows a user to interact with computing the system 800 via body, hand or face gestures. For example, a user's hand gestures can be detected and interpreted to provide input to a gaming application.

The I/O devices 864 can include at least one input/output port comprising physical connectors (e.g., USB, IEEE 1394 (FireWire), Ethernet, RS-232), a power supply (e.g., battery), a global satellite navigation system (GNSS) receiver (e.g., GPS receiver); a gyroscope; an accelerometer; and/or a compass. A GNSS receiver can be coupled to a GNSS antenna. The computing system 800 can further comprise one or more additional antennas coupled to one or more additional receivers, transmitters, and/or transceivers to enable additional functions.

In addition to those already discussed, integrated circuit components, integrated circuit constituent components, and other components in the computing system 894 can communicate with interconnect technologies such as Intel® QuickPath Interconnect (QPI), Intel® Ultra Path Interconnect (UPI), Computer Express Link (CXL), cache coherent interconnect for accelerators)(CCIX®), serializer/deserializer (SERDES), Nvidia® NVLink, ARM Infinity Link, Gen-Z, or Open Coherent Accelerator Processor Interface (OpenCAPI). Other interconnect technologies may be used and a computing system 894 may utilize more or more interconnect technologies.

It is to be understood that FIG. 8 illustrates only one example computing system architecture. Computing systems based on alternative architectures can be used to implement technologies described herein. For example, instead of the processors 802 and 804 and the graphics engine 852 being located on discrete integrated circuits, a computing system can comprise an SoC (system-on-a-chip) integrated circuit incorporating multiple processors, a graphics engine, and additional components. Further, a computing system can connect its constituent component via bus or point-to-point configurations different from that shown in FIG. 8. Moreover, the illustrated components in FIG. 8 are not required or all-inclusive, as shown components can be removed and other components added in alternative embodiments.

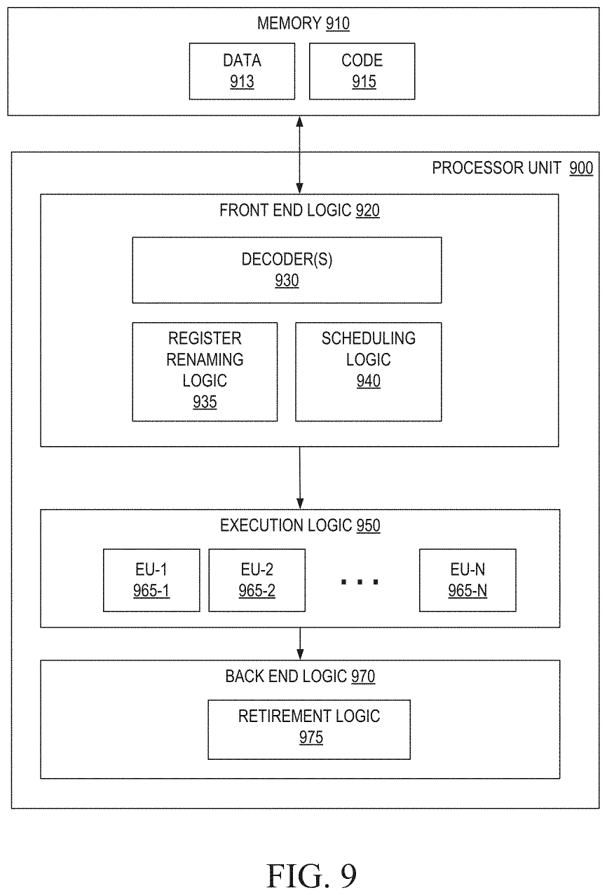

FIG. 9 is a block diagram of an example processor unit 900 to execute computer-executable instructions as part of implementing technologies described herein. Processor 900 is one possible example of other processors, processing units, processing circuitry, and any other processing elements (e.g., 106, 114, 430, 530) shown and described herein. The processor unit 900 can be a single-threaded core or a multithreaded core in that it may include more than one hardware thread context (or “logical processor”) per processor unit.

FIG. 9 also illustrates a memory 910 coupled to the processor unit 900. The memory 910 can be any memory described herein or any other memory known to those of skill in the art. The memory 910 can store computer-executable instructions 915 (code) executable by the processor unit 900.

The processor unit comprises front-end logic 920 that receives instructions from the memory 910. An instruction can be processed by one or more decoders 930. The decoder 930 can generate as its output a micro-operation such as a fixed width micro-operation in a predefined format, or generate other instructions, microinstructions, or control signals, which reflect the original code instruction. The front-end logic 920 further comprises register renaming logic 935 and scheduling logic 940, which generally allocate resources and queues operations corresponding to converting an instruction for execution.

The processor unit 900 further comprises execution logic 950, which comprises one or more execution units (EUs) 965-1 through 965-N. Some processor unit embodiments can include a few execution units dedicated to specific functions or sets of functions. Other embodiments can include only one execution unit or one execution unit that can perform a particular function. The execution logic 950 performs the operations specified by code instructions. After completion of execution of the operations specified by the code instructions, back-end logic 970 retires instructions using retirement logic 975. In some embodiments, the processor unit 900 allows out of order execution but requires in-order retirement of instructions. Retirement logic 975 can take a variety of forms as known to those of skill in the art (e.g., re-order buffers or the like).

The processor unit 900 is transformed during execution of instructions, at least in terms of the output generated by the decoder 930, hardware registers and tables utilized by the register renaming logic 935, and any registers (not shown) modified by the execution logic 950.

Any of the disclosed methods (or a portion thereof) can be implemented as computer-executable instructions (also referred to as machine readable instructions) or a computer program product stored on a computer readable (machine readable) storage medium. Such instructions can cause a computing system or one or more processor units capable of executing computer-executable instructions to perform any of the disclosed methods.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some embodiments, any of the methods herein can be performed by a combination of non-programmable hardware components and one or more processing units executing computer-executable instructions stored on computer-readable storage media.

The computer-executable instructions can be part of, for example, an operating system of the host or computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, Web Assembly, or any other programming language.

Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

While the concepts of the present disclosure are susceptible to various modifications and alternative forms, specific embodiments thereof have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but it is not necessary that every embodiment include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The following examples pertain to additional embodiments of technologies disclosed herein.

The following examples pertain to embodiments in accordance with this specification. Example A1 provides an apparatus that includes interface processing circuitry configured to be communicatively coupled to a memory and a processor. The interface processing circuitry is to obtain, from a first module compiled from a first software language, first data having a first native type of the first software language. The interface processing circuitry is further to convert the first data into second data having a first interface type, convert the second data having the first interface type into third data having a second native type of a second software language, and provide the third data to a second module associated with the second software language.

Example A2 comprises the subject matter of Example A1, and the first software language is compiled to WebAssembly binary code.

Example A3 comprises the subject matter of any one of Examples A1-A2, and the second module is compiled from the second software language to WebAssembly binary code.

Example A4 comprises the subject matter of any one of Examples A1-A3, and the second software language is different than the first software language.

Example A5 comprises the subject matter of any one of Examples A1-A4, and the second module is compiled to object code based on the second software language and is to run in a native runtime of the second software language.

Example A6 comprises the subject matter of any one of Examples A1-A5, and the second module is a WebAssembly system interface to an operating system or to one or more application programming interfaces (APIs) of a browser to run on the processor.

Example A7 comprises the subject matter of any one of Examples A1-A6, and converting the first data into second data having a first interface type includes a first hardware computation to be performed by the interface processing circuitry in response to the first module initiating the interface processing circuitry.

Example A8 comprises the subject matter of Examples A7, and load a first instruction sequence on the interface processing circuitry to perform the first hardware computation.

Example A9 comprises the subject matter of any one of Examples A1-A8, and converting the second data having the first interface type into third data having a second native type includes a second hardware computation to be performed by the interface processing circuitry in response to the second module initiating the interface processing circuitry.

Example A10 comprises the subject matter of Examples A9, and the interface processing circuitry is further to load the second instruction sequence on the interface processing circuitry to perform the second hardware computation.

Example A11 comprises the subject matter of any one of Examples A1-A10, and the memory is to include a first linear memory space allocated to the first module and a second linear memory space allocated to the second module, and a shared memory region is to be designated in a portion of the first linear memory space.

Example A12 comprises the subject matter of Examples A11, and the second module is to be permitted to at least read from the shared memory region, and the first module is to be permitted to read from the shared memory region and write to the shared memory region.

Example A13 comprises the subject matter of any one of Examples A1-A12, and the interface processing circuitry is further to fetch the first data from a shared memory region in response to being initiated by the first module, and/or store the second data in the shared memory region subsequent to converting the first data into the second data having the first interface type, and/or fetch the second data from the shared memory region in response to being initiated by the second module, and/or store the third data in the shared memory region subsequent to converting the second data into the third data.

Example A14 comprises the subject matter of any one of Examples A1-A13, and the interface processing circuitry is implemented on a reduced instruction set computer (RISC-V) or a complex instruction set computer (CISC).

Example A15 comprises the subject matter of any one of Examples A1-A14, and the first data is one of return data generated by the first module in response to being called by the second module, or a parameter generated by the first module to be communicated as part of calling the second module.

Example A16 comprises the subject matter of any one of Examples A1-A15, and the second data further has one or more other interface types.

Example S1 provides a system including an interface processor and a first processor communicatively coupled to the interface processor. The first processor is to execute a first module compiled from a first software language to initiate the interface processor and initiate a communication of first data having a first native type of the first software language to a second module associated with a second software language. The interface processor is to convert the first data into second data having a first interface type, convert the second data into third data having a second native type of the second software language, and provide the third data to the second module.

Example S2 comprises the subject matter of Example S1, and the first software language is compiled to WebAssembly binary code.

Example S3 comprises the subject matter of any one of Examples S1-52, and the second module is compiled from the second software language to WebAssembly binary code.

Example S4 comprises the subject matter of any one of Examples S1-53, and the second software language is different than the first software language.

Example S5 comprises the subject matter of any one of Examples S1-54, and the second module is compiled to object code based on the second software language and is to run in a native runtime of the second software language.

Example S6 comprises the subject matter of any one of Examples S1-55, and the second module is a WebAssembly system interface to an operating system or to one or more application programming interfaces (APIs) of a browser to run on the first processor.

Example S7 comprises the subject matter of any one of Examples S1-56, and converting the first data into second data having a first interface type includes a first hardware computation to be performed by the interface processor in response to the first module initiating the interface processor.

Example S8 comprises the subject matter of Examples S7, and load a first instruction sequence on the interface processor to perform the first hardware computation.

Example S9 comprises the subject matter of any one of Examples S1-S8, and converting the second data having the first interface type into third data having a second native type includes a second hardware computation to be performed by the interface processor in response to the second module initiating the interface processor.

Example S10 comprises the subject matter of Examples S9, and the interface processor is further to, load a second instruction sequence on the interface processor to perform the second hardware computation.

Example S11 comprises the subject matter of any one of Examples S1-S10, and the system further comprises memory coupled to the first processor and the interface processor, and the memory is to include a first linear memory space allocated to the first module, a second linear memory space allocated to the second module, and a shared memory region to be designated in a portion of the first linear memory space.

Example S12 comprises the subject matter of Examples S11, and the second module is to be permitted to at least read from the shared memory region, and the first module is to be permitted to read from the shared memory region and write to the shared memory region.

Example S13 comprises the subject matter of any one of Examples S1-S12, and the interface processor is further to fetch the first data from a shared memory region in response to being initiated by the first module, and/or store the second data in the shared memory region subsequent to converting the first data into the second data having the first interface type, and/or fetch the second data from the shared memory region in response to being initiated by the second module, and/or store the third data in the shared memory region subsequent to converting the second data into the third data.

Example S14 comprises the subject matter of any one of Examples S1-S13, and the interface processor is implemented on a reduced instruction set computer (RISC-V) or a complex instruction set computer (CISC).

Example S15 comprises the subject matter of any one of Examples S1-S14, and the first data is one of return data generated by the first module in response to being called by the second module, or a parameter generated by the first module to be communicated as part of calling the second module.

Example S16 comprises the subject matter of any one of Examples S1-S15, and the second data further has one or more other interface types.

Example C1 provides one or more machine readable storage media, including instructions stored therein, and the instructions, when executed by an interface processor, cause the interface processor to obtain first data having a first native type of a first software language from a first module compiled from the first software language, convert the first data into second data having a first interface type, convert the second data having the first interface type into third data having a second native type of a second software language, and provide the third data to a second module associated with the second software language.

Example C2 comprises the subject matter of Example C1, and the the first software language is compiled to WebAssembly binary code.

Example C3 comprises the subject matter of any one of Examples C1-C2, and the second module is compiled from the second software language to WebAssembly binary code.

Example C4 comprises the subject matter of any one of Examples C1-C3, and the second software language is different than the first software language.

Example C5 comprises the subject matter of any one of Examples C1-C4, and the second module is compiled to object code based on the second software language and is to run in a native runtime of the second software language.

Example C6 comprises the subject matter of any one of Examples C1-05, and the second module is a WebAssembly system interface to an operating system or to one or more application programming interfaces (APIs) of a browser.

Example C7 comprises the subject matter of any one of Examples C1-C6, and converting the first data into second data having a first interface type includes a first hardware computation to be performed in response to the first module initiating the interface processor.

Example C8 comprises the subject matter of Examples C7, and the instructions are to be loaded on the interface processor to perform the first hardware computation.

Example C9 comprises the subject matter of any one of Examples C1-C8, and converting the first data into second data having a first interface type includes a second hardware computation to be performed in response to the second module initiating the interface processor.

Example C10 comprises the subject matter of Examples C9, and the instructions are to be loaded on the interface processor to perform the first hardware computation.

Example C11 comprises the subject matter of any one of Examples C1-C10, and the instructions, when executed by the interface processor, cause the interface processor to fetch the first data from a shared memory region in response to being initiated by the first module, and/or store the second data in the shared memory region subsequent to converting the first data into the second data having the first interface type, and/or fetch the second data from the shared memory region in response to being initiated by the second module, and/or store the third data in the shared memory region subsequent to converting the second data into the third data.

Example C12 comprises the subject matter of Examples C11, and the memory is to include a first linear memory space allocated to the first module and a second linear memory space allocated to the second module, and the shared memory region is to be designated in a portion of the first linear memory space.

Example C13 comprises the subject matter of any one of Examples C1-C12, and the second module is to be permitted to at least read from the shared memory region, and the first module is to be permitted to read from the shared memory region and write to the shared memory region.

Example C14 comprises the subject matter of any one of Examples C1-C13, and the interface processor is implemented on a reduced instruction set computer (RISC-V) or a complex instruction set computer (CISC).

Example C15 comprises the subject matter of any one of Examples C1-C14, and the first data is one of return data generated by the first module in response to being called by the second module, or a parameter generated by the first module to be communicated as part of calling the second module.

Example C16 comprises the subject matter of any one of Examples C1-C15, and the second data further has one or more other interface types.

Example M1 provides a method comprising: initiating, by a first module compiled from a first software language and running on a first processor, an interface processor; initiating, by the first module, a communication of first data having a first native type of the first software language to a second module associated with a second software language, converting, by the interface processor, the first data into second data having a first interface type; converting the second data having the first interface type into third data having a second native type of the second software language; and storing the third data in a shared memory region of memory to be accessed by the second module.

Example M2 comprises the subject matter of Example M1, and the first software language is compiled to WebAssembly binary code.

Example M3 comprises the subject matter of any one of Examples M1-M2, and the second module is compiled from the second software language to WebAssembly binary code.

Example M4 comprises the subject matter of any one of Examples M1-M3, and the second software language is different than the first software language.

Example M5 comprises the subject matter of any one of Examples M1-M4, and the second module is compiled to object code based on the second software language and is to run in a native runtime of the second software language.

Example M6 comprises the subject matter of any one of Examples M1-M5, and the second module is a WebAssembly system interface to an operating system or to one or more application programming interfaces (APIs) of a browser to run on the first processor.

Example M7 comprises the subject matter of any one of Examples M1-M6, and converting the first data into second data having a first interface type includes performing a first hardware computation in response to the first module initiating the interface processor.

Example M8 comprises the subject matter of Examples M7, and further comprises loading the first instruction sequence on the interface processor.

Example M9 comprises the subject matter of any one of Examples M1-M8, and converting the second data having the first interface type into third data having a second native type includes a performing the second hardware computation in response to the second module initiating the interface processor.

Example M10 comprises the subject matter of Examples M9, and further comprises receiving, by the interface processor, a second instruction sequence from the second module, and loading the second instruction sequence on the interface processor.

Example M11 comprises the subject matter of any one of Examples M1-M10, and the memory includes a first linear memory space allocated to the first module and a second linear memory space allocated to the second module, and the shared memory region is designated in a portion of the first linear memory space.

Example M12 comprises the subject matter of Examples M11, and the second module is permitted to at least read from the shared memory region, and the first module is permitted to read from the shared memory region and write to the shared memory region.

Example M13 comprises the subject matter of any one of Examples M1-M12, and further includes fetching the first data from a shared memory region in response to being initiated by the first module, and/or storing the second data in the shared memory region subsequent to converting the first data into the second data having the first interface type, and/or fetching the second data from the shared memory region in response to being initiated by the second module, and/or storing the third data in the shared memory region subsequent to converting the second data into the third data.

Example M14 comprises the subject matter of any one of Examples M1-M13, and the interface processor is implemented on a reduced instruction set computer (RISC-V) or a complex instruction set computer (CISC).

Example M15 comprises the subject matter of any one of Examples M1-M14, and the first data is one of return data generated by the first module in response to being called by the second module, or a parameter generated by the first module to be communicated as part of calling the second module.

Example M16 comprises the subject matter of any one of Examples M1-M15, and the second data further has one or more other interface types.

Example X1 provides an apparatus comprising means for performing the method of any one of Examples M1-M16.

Example X2 comprises the subject matter of Example X1 and the means for performing the method comprises an interface processor.

Example X3 comprises any one of Examples X1-X2 and the means for performing the method comprises at least one processor and at least one memory element.

Example X4 comprises the subject matter of Example X3 can optionally include that the at least one memory element comprises machine readable instructions that when executed, cause the apparatus to perform the method of any one of Examples M1-M16.

Example X5 comprises the subject matter of any one of Examples X1-X4 can optionally include that the apparatus is one of a computing system, a processing element, or a system-on-a-chip.

Example Y1 provides at least one machine readable storage medium comprising instructions that when executed by one or more processors, causes the one or more processors to realize an apparatus, realize a system, or implement a method as in any one of the preceding Examples.

What is claimed is:

1. An apparatus, comprising:
interface processing circuitry configured to be communicatively coupled to a memory and a processor, the interface processing circuitry to:
obtain, from a first module compiled from a first software language, first data having a first native type of the first software language;
convert the first data into second data having a first interface type;
convert the second data having the first interface type into third data having a second native type of a second software language; and
provide the third data to a second module associated with the second software language.

2. The apparatus of claim 1, wherein the first software language is compiled to WebAssembly binary code.

3. The apparatus of claim 2, wherein the second module is compiled from the second software language to WebAssembly binary code.

4. The apparatus of claim 3, wherein the second software language is different than the first software language.

5. The apparatus of claim 2, wherein the second module is compiled to object code based on the second software language and is to run in a native runtime of the second software language.

6. The apparatus of claim 2, wherein the second module is a WebAssembly system interface to an operating system or to one or more application programming interfaces (APIs) of a browser to run on the processor.

7. The apparatus of claim 1, wherein converting the first data into second data having a first interface type includes a first hardware computation to be performed by the interface processing circuitry in response to the first module initiating the interface processing circuitry.

8. The apparatus of claim 7, wherein the interface processing circuitry is further to:
load a first instruction sequence on the interface processing circuitry to perform the first hardware computation.

9. The apparatus of claim 1, wherein converting the second data having the first interface type into third data having a second native type includes a second hardware computation to be performed by the interface processing circuitry in response to the second module initiating the interface processing circuitry.

10. The apparatus of claim 9, wherein the interface processing circuitry is further to:
load a second instruction sequence on the interface processing circuitry to perform the second hardware computation.

11. The apparatus of claim 1, wherein the memory is to include a first linear memory space allocated to the first module and a second linear memory space allocated to the second module, wherein a shared memory region is to be designated in a portion of the first linear memory space.

12. The apparatus of claim 11, wherein the second module is to be permitted to at least read from the shared memory region, wherein the first module is to be permitted to read from the shared memory region and write to the shared memory region.

13. The apparatus of claim 1, wherein the interface processing circuitry is further to:
in response to being initiated by the first module, fetch the first data from a shared memory region;
subsequent to converting the first data into the second data having the first interface type, store the second data in the shared memory region; and
in response to being initiated by the second module, fetch the second data from the shared memory region.

14. The apparatus of claim 1, wherein the interface processing circuitry is implemented on a reduced instruction set computer (RISC-V) or a complex instruction set computer (CISC).

15. The apparatus of claim 1, wherein the first data is one of:
return data generated by the first module in response to being called by the second module; or
a parameter generated by the first module to be communicated as part of calling the second module.

16. The apparatus of claim 1, wherein the second data further has one or more other interface types.

17. A system, comprising:
an interface processor; and
a first processor communicatively coupled to the interface processor, the first processor to execute a first module compiled from a first software language to:
initiate the interface processor; and
initiate a communication of first data having a first native type of the first software language to a second module associated with a second software language, wherein the interface processor is to:
convert the first data into second data having a first interface type;
convert the second data into third data having a second native type of the second software language; and
provide the third data to the second module.

18. The system of claim 17, wherein the first software language is compiled to WebAssembly binary code.

19. The system of claim 17, wherein the second module is compiled from the second software language to WebAssembly binary code, and wherein the second software language is different than the first software language.

20. The system of claim 18, wherein the second data further has one or more other interface types.

21. A method comprising:
initiating, by a first module compiled from a first software language and running on a first processor, an interface processor;
initiating, by the first module, a communication of first data having a first native type of the first software language to a second module associated with a second software language;
converting, by the interface processor, the first data into second data having a first interface type;
converting the second data having the first interface type into third data having a second native type of the second software language; and
storing the third data in a shared memory region of memory to be accessed by the second module.

22. The method of claim 21, wherein the first software language is compiled to WebAssembly binary code.

23. The method of claim 21, wherein the second module is one of:
compiled from the second software language to WebAssembly binary code,
compiled to object code based on the second software language, or
a WebAssembly system interface to an operating system or application programming interface of a browser.

24. One or more machine readable media including instructions stored therein, wherein the instructions, when executed by an interface processor, cause the interface processor to:
obtain first data having a first native type of a first software language from a first module compiled from the first software language;
convert the first data into second data having a first interface type;
convert the second data having the first interface type into third data having a second native type of a second software language; and
provide the third data to a second module associated with the second software language.

25. The one or more machine readable media of claim 24, wherein the instructions, when executed by the interface processor, cause the interface processor further to:
in response to being initiated by the first module, fetch the first data from a shared memory region of a memory;
subsequent to converting the first data into the second data having the first interface type, store the second data in the shared memory region; and
in response to being initiated by the second module, fetch the second data from the shared memory region.
